(19) United States
(12) Patent Application Publication
(10) Pub. No.: US 2014/0301378 A1
(43) Pub. Date: Oct. 9, 2014

(54) METHOD FOR IMPLEMENTING NEIGHBOR DISCOVERY PROTOCOL IN A WLAN

(71) Applicant: Guoxiang Xu, Beijing (CN)

(72) Inventor: Guoxiang Xu, Beijing (CN)

(73) Assignee: Hangzhou H3C Technologies Co., Ltd., Hangzhou, Zhejiang (CN)

(21) Appl. No.: 14/009,052

(22) PCT Filed: Nov. 23, 2011
(86) PCT No.: PCT/CN2011/082728

§ 371 Date: Sep. 30, 2013

(30) Foreign Application Priority Data
May 30, 2011 (CN) 201110143536.5

(51) Int. Cl. H04W 48/16

(52) U.S. Cl. CPC H04W 48/16
USPC 370/338

(57) ABSTRACT

A method for implementing neighbor discovery protocol in a wireless local area network (WLAN) and an access point (AP). In the method, the AP prestores the logic group of each wireless client associated to the AP, determines the logic group of a neighbor discovery protocol related message when the message is received by the AP, and transmits the neighbor discovery protocol related message to at least one wireless client included in the logic group of the message via a unicast mode, respectively, according to prestored information relating to the logic group of each wireless client associated to the AP.

### BACKGROUND

Neighbor discovery (ND) protocol is one of the basic protocols for networking applications, such as, Internet Protocol Version 6 (IPv6) protocol suite, which implements functions including, gateway discovery, address auto-configuration, address resolution, next hop search, neighbor unreachable detection, duplicate address detection. The functions are implemented mainly through neighbor discovery protocol related messages, such as a router solicitation message, a router advertisement message, a neighbor solicitation message and a neighbor advertisement message, in which most of the messages are transmitted via a multicast mode. For example, as to gateway discovery and address auto-configuration, a host may send a router solicitation message to all of the router multicast groups after the host has started. Then, a router in the subnet that receives the router solicitation message will reply with a router advertisement message via a unicast mode as a response. Also, the router can periodically send out a router advertisement message via a multicast mode on its own initiative. The router advertisement message includes information for host address auto-configuration. The host may automatically configure an appropriate address for its network card according to its own MAC address and the address prefix carried in the router advertisement message after receiving the router advertisement message.

### BRIEF DESCRIPTION OF THE DRAWINGS

FIG. 1 is a schematic diagram illustrating a structure of clients from different VLANs having the same SSID accessing a network;

FIG. 2 is a flow chart illustrating a method for implementing neighbor discovery protocol in a wireless local area network (WLAN) according to an example of the present disclosure;

FIG. 3 is a schematic diagram illustrating a structure of an access point (AP) according to an example of the present disclosure; and

FIG. 4 illustrates a specific implementation of an access point according to an example of the present disclosure.

### DETAILED DESCRIPTION

Wireless local area network (WLAN) is a media share network similar to Ethernet. All wireless clients such as hosts and routers with wireless network cards and wireless access points (AP) transmit information in the WLAN through an air interface. However, in Ethernet, the subnets of hosts sharing the same media are generally within the same network segment, and the hosts belong to the same logic group, e.g., belong to the same virtual local area network (VLAN). As to the WLAN, hosts belonging to different logic groups share the same media in most cases. As shown in FIG. 1, which is a schematic diagram illustrating the structure of clients from different VLANs having the same SSID accessing a network, clients A and C belonging to VLAN100 and client B belonging to VLAN200 share the air interface media, but they belong to different subnets and they don't belong to the same logic group.

Based on the above-mentioned differences between WLAN and Ethernet, there may be problems if the neighbor discovery protocol is directly deployed on the WLAN in the same manner as Ethernet. This situation is illustrated hereinafter in combination with FIG. 1. Taking a router advertisement message as an example, when the router advertisement message sent out by a router via a multicast mode reaches an AP, the AP will broadcast the message to all wireless clients through the air interface. Thus, a wireless client, e.g., wireless client B, having the same service set identifier (SSID), while not belonging to the logic group of the router, may also receive the router advertisement message. Meanwhile, since wireless client B is unable to identify its logic group, wireless client B may take the router advertisement message as an advertisement of its own logic group, add the router sending out the router advertisement message into its gateway list, and automatically configure its network card address based on the address prefix carried in the router advertisement message, which may result in address configuration error and entire network confusion. It should be noted that neighbor discovery protocol cannot work normally when it is directly deployed in the WLAN in the same way it is used in the Ethernet.

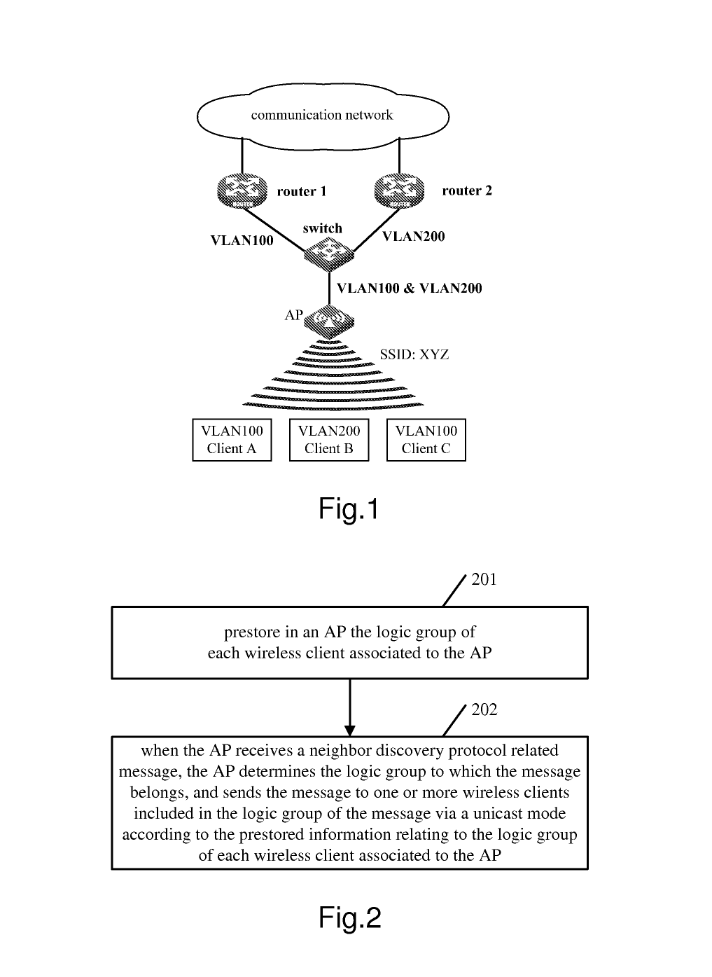

Therefore, a method for implementing neighbor discovery protocol in the WLAN is provided as an example of the present disclosure, which includes the following operations shown in FIG. 2.

Block 201: prestore in an AP the logic group of each wireless client associated to the AP.

It should be noted that an AP may only forward messages for wireless clients associated to the AP itself. Hence, each wireless client is able to communicate only if it associates to an AP, wherein the process of a wireless client associating to an AP may refer to existing technologies. When the wireless client has established an association with the AP, the AP will record relevant information of the wireless client, such as the VLAN to which the wireless client belongs.

In a specific implementation, the wireless client may either be a host or a router, wherein the host or the router may wirelessly connect to a network.

Furthermore, there are a variety of ways for dividing wireless clients into different logic groups. For example, each wireless client may be classified according to its VLAN, wherein wireless clients belonging to the same VLAN belong to the same logic group. Also, the logic group of each wireless client may be directly configured via a management interface wherein logic group managing configuration is performed by an administrator, or distinguished according to its SSID. For example, different network segments are configured according to SSIDs and different SSIDs are divided into different subnets, wherein wireless clients having different SSIDs belong to different logic groups. In the present disclosure, the method of dividing logic groups according to VLANs of wireless clients is further described hereinafter. In practical application, different implementations may be employed for specifying the VLAN of each wireless client, e.g., the AP may specify the VLAN for each wireless client according to the wireless client's SSID, or a Remote Authentication Dial In User Service (Radius) server may specify the VLAN to which each wireless client belongs, which may refer to existing technologies. It should be noted that other ways of dividing logic groups may be employed.

Block 202: when the AP receives a neighbor discovery protocol related message, the AP determines the logic group to which the message belongs, and sends the message to at least one wireless client included in the logic group of the message via a unicast mode according to the prestored information relating to the logic group of each wireless client associated to the AP.

At this block, the neighbor discovery protocol related message is transmitted from a wireless client or a wired network via a multicast mode, wherein the message may be a router solicitation message, a router advertisement message, a neighbor solicitation message, or a neighbor advertisement message. When the message is sent from the wired network, the AP may discover at least one wireless client belonging to the logic group of the message from all the wireless clients associated to the AP, and transmit the message to the at least one wireless client via a unicast mode. When the message is transmitted from a particular wireless client, the AP may identify wireless clients belonging to the logic group of the message from all the other wireless clients associated to the AP apart from the particular wireless client, and transmit the message to the identified wireless clients via a unicast mode.

The method for determining the logic group of messages received from a wired network differs from messages received from a wireless client. When the message is sent from a wired network via a multicast mode, the method for determining the logic group of the message includes: determining whether the message carries a logic group identifier, and if so, taking the logic group identified by the logic group identifier carried in the message as the logic group of the message; otherwise, taking the default logic group of the interface in the AP from which the message is received as the logic group of the message. Here, the logic group identifier carried in the message may be a VLAN identifier. In addition, each interface is designated a default VLAN, i.e., the default logic group of the interface, which may refer to existing technologies. When the message is transmitted from a wireless client via a multicast mode, the method for determining the logic group of the message includes: determining the logic group of the wireless client from which the message is transmitted according to information stored in the AP relating to the logic group of each wireless client associated to the AP, and taking the logic group of the wireless client from which the message is transmitted as the logic group of the message.

If the message the AP receives is sent from a wired network, it is only required to transmit the message within a same VLAN in accordance with existing technologies when the message is to be forwarded within the wired network. When the message is to be forwarded by the AP to wireless clients after the message is sent to the AP, it is required to send the message to the wireless clients having the same logic group as that of the message via a unicast mode. If the message the AP receives is sent from a wireless client, the AP will transmit the message to other wireless clients having the same logic group as that of the message via a unicast mode, and further broadcast the message to a wired network as usual to enable the message to be transmitted within the wired network. Here, since the message can only be transmitted within the same VLAN of the wired network, and there is no possibility of spreading the message to a different VLAN, the message is only required to be normally multicast on an Ethernet interface.

In addition, due to an inherent retransmission mechanism of messages in the WLAN, a message should be buffered in a memory before it is sent successfully from the AP to a wireless client via a unicast mode. If the message is sent successfully, which is indicated by an acknowledgement (ACK) message received from the peer, the message is removed from the memory; if the message is not sent successfully, retransmission is required. Therefore, a maximum retention time of a message in the memory should be determined. As to general messages, they have the same retention time. However, as to the retransmission mechanism for neighbor discovery protocol related messages in the WLAN, the maximum retention time may simply be set according to a neighbor discovery protocol parameter, i.e., retransmission timer (Retrans Timer), and is not necessary to exceed the time specified in the parameter. Here, the value of the Retrans Timer parameter is generally carried into the router advertisement message by a router. Therefore, when the AP receives a router advertisement message, the value of the Retrans Timer parameter contained in the router advertisement message is obtained and used as the maximum retention time of a received neighbor discovery protocol related message in the AP before the neighbor discovery protocol related message is transmitted from the AP to a wireless client via a unicast mode.

The above are detailed descriptions for the method provided in the present disclosure, and the device of the present disclosure will be described in detail in the following.

The present disclosure also provides an AP, which may guarantee a normal operation of neighbor discovery protocol in the WLAN.

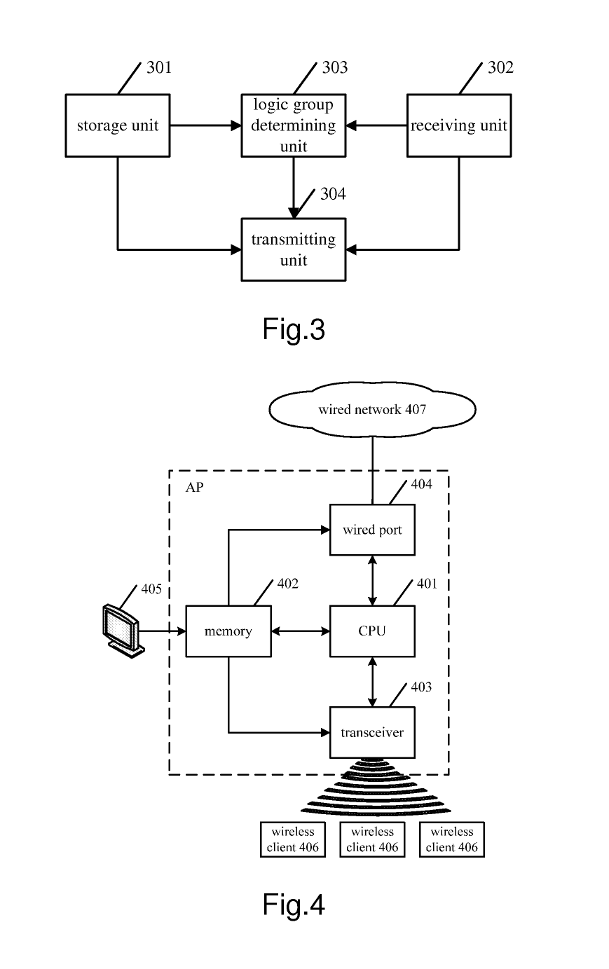

FIG. 3 is a schematic diagram illustrating the structure of an AP according to an example of the present disclosure, wherein the AP is specifically used in the WLAN adopting neighbor discovery protocol. The AP includes: a storage unit 301, a receiving unit 302, a logic group determination unit 303 and a transmitting unit 304.

The storage unit 301 is to prestore the logic group of each wireless client associated to the AP.

The receiving unit 302 is to receive a neighbor discovery protocol related message transmitted from a wireless client or a wired network via a multicast mode, and to provide the message to the logic group determination unit 303 and the transmitting unit 304.

The logic group determination unit 303 is to determine the logic group of the neighbor discovery protocol related message after receiving the message from the receiving unit 302.

The transmitting unit 304 is to transmit the neighbor discovery protocol related message to the at least one wireless client included in the logic group of the message via a unicast mode, respectively, according to the logic group of each wireless client prestored in the storage unit 301 and the logic group of the message determined by the logic group determination unit 303, after receiving the neighbor discovery protocol related message from the receiving unit 302.

In a specific implementation, the neighbor discovery protocol related message received by the receiving unit 302 is one of a router solicitation message, a router advertisement message, a neighbor solicitation message, a neighbor advertisement message, etc.

In a specific implementation, the wireless client is a host or router accessing the AP in a wireless manner.

Further, the logic group determination unit 303 is to determine, when the neighbor discovery protocol related message is transmitted from a wired network via a multicast mode, whether the message carries a logic group identifier, and if yes, to take the logic group identified by the logic group identifier carried in the message as the logic group of the message; otherwise, to take the default logic group of the interface from which the message is received as the logic group of the message.

Further, the logic group determination unit 303 is to determine, when the neighbor discovery protocol related message is transmitted from a wireless client via a multicast mode, the logic group of the wireless client from which the message is transmitted according to the logic group of each wireless client associated to the AP prestored in the AP, and to take the logic group of the wireless client from which the message is transmitted as the logic group of the message.

In a specific implementation, the AP may distinguish the logic group of each wireless client according to the VLAN to which the wireless client belongs, directly specify a logic group for each wireless client, or use the SSID of each wireless client to identify its logic group. Accordingly, the logic group determination unit 303 is to determine the logic group of the message according to the virtual local area network (VLAN) to which the wireless client transmitting the message belongs, according to the service set identifier (SSID) of the wireless client transmitting the message, or according to the logic group managing configuration for the wireless client transmitting the message.

The transmitting unit 304 is further to normally multicast the message to the wired network when transmitting the message to other wireless clients having the same logic group as that of the message via a unicast mode.

Further, the logic group determination unit 303 is to obtain relevant information of a wireless client when it is associated to the AP, such as the VLAN, to which the wireless client belongs and its corresponding SSID, and to save the relevant information to the storage unit 301.

The AP further includes: a message retention unit to obtain, when the message is a router advertisement message, a time value contained in the retransmission timer (Retrans Timer) field of the router advertisement message, and take the time value as the maximum retention time in the AP of any neighbor discovery protocol related message when any neighbor discovery protocol related message is transmitted to other wireless clients by the AP via a unicast mode. In a specific example, the message retention unit may be achieved by a processor or central processing unit (CPU), for setting the maximum retention time of neighbor discovery protocol related messages, in order to control the memory to reserve or delete the messages.

FIG. 4 shows a specific application of the present disclosure. Specifically, the logic group determination unit 303 in the AP may be a processor or central processing unit (CPU) 401; the storage unit 301 may be a common memory 402 for storing the logic group of each wireless client associated to the AP, wherein the information of logic group may be configured via a management interface 405 located at an access point controller (AC) or an access point (AP), or provided by the CPU 401; the receiving unit 302 and the transmitting unit 304 in a wireless network can be a transceiver 403, e.g., a radio frequency (RF) card, wherein the transceiver 403 is connected with a wireless client 406; the receiving unit 302 and the transmitting unit 304 in a wired network (such as Ethernet, Internet, etc.) 407 can be a wired port 404 such as a modem for connecting the wired network 407, wherein the wired port 404 further includes multiple interfaces, each of which has a default VLAN.

In a specific implementation, the wired port 404 of the AP receives from the wired network 407, a neighbor discovery protocol related message transmitted via a multicast mode. After processing of the CPU 401, the message is provided to the RF card 403 and then sent to the wireless client 406 via a unicast mode.

In another specific implementation, the RF card 403 of the AP receives from the WLAN a neighbor discovery protocol related message sent out via a multicast mode. After processing by the CPU 401, the message will be provided to the RF card 403 and sent to a wireless client 406 via a unicast mode, and further provided to a wired port 404 and sent to a wired network 407 via a multicast mode.

In an example, a method for implementing IPv6 neighbor discovery protocol in the WLAN is presented in the present disclosure, which provides a normal operation of IPv6 neighbor discovery protocol in the WLAN.

The method includes: prestoring, in an AP, the logic group of each wireless client associated to the AP, wherein the wireless client is a host or router;

when the AP receives a neighbor discovery protocol related message sent from a wireless client or a wired network via a multicast mode, determining the logic group to which the message belongs, and sending the message via a unicast mode to other wireless clients having the same logic group as that of the message, respectively, according to the pre-stored logic group of each wireless client associated with the AP.

It can be seen from the above disclosure that, in the present disclosure, the logic groups of all the wireless clients associated with the AP are pre-stored in the AP. When the AP receives a neighbor discovery protocol related message sent out from a wireless client or a wired network via a multicast mode, the AP will send the message to other wireless clients belonging to the same logic group as that of the message in a unicast mode, which may avoid incorrect address and gateway configuration caused by transmission of the message to wireless clients having a different logic group with the message. Therefore, the IPv6 neighbor discovery protocol may be normally operated in the WLAN.

In other words, through use of the method provided in the present disclosure, the AP will no longer broadcast a received multicast message of IPv6 neighbor discovery protocol within the WLAN. Instead, the multicast message is transmitted to each of the wireless clients included in the logic group of the message via a unicast mode, which may avoid configuration confusion of the IPv6 network caused by the transmission of messages to different subnets and also may avoid interference to wireless clients caused by unnecessary broadcasts between different subnets. It should be noted that the client described in the present disclosure refers to a wireless client.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for implementing neighbor discovery protocol in a wireless local area network (WLAN), comprising:
prestoring in an access point (AP), the logic group of each wireless client associated to the AP; and
determining the logic group of a neighbor discovery protocol related message when the message is received by the AP, and transmitting the neighbor discovery protocol related message to at least one wireless client included in the logic group of the message via a unicast mode, respectively, according to prestored information relating to the logic group of each wireless client associated to the AP.

2. The method for implementing neighbor discovery protocol in a WLAN according to claim 1, wherein the neighbor discovery protocol related message is transmitted from a wired network via a multicast mode; and
wherein determining the logic group of the neighbor discovery protocol related message comprises:
determining whether the message carries a logic group identifier;
in response to a determination that the message carries a logic group identifier, taking the logic group identified by the logic group identifier carried in the message as the logic group of the message; and
in response to a determination that the message does not carry a logic group identifier, taking the default logic group of the interface from which the message is received in the AP as the logic group of the message.

3. The method for implementing neighbor discovery protocol in a WLAN according to claim 1, wherein the neighbor discovery protocol related message is transmitted from a wireless client via a multicast mode; and
wherein determining the logic group of the neighbor discovery protocol related message comprises:
determining the logic group of the wireless client from which the message is transmitted according to the prestored information relating to the logic group of each wireless client associated to the AP, and taking the logic group of the wireless client from which the message is transmitted as the logic group of the message.

4. The method for implementing neighbor discovery protocol in a WLAN according to claim 3, wherein determining the logic group of the neighbor discovery protocol related message comprises: determining the logic group of the message according to the virtual local area network (VLAN) to which the wireless client transmitting the message belongs, or according to the service set identifier (SSID) of the wireless client transmitting the message, or according to the logic group managing configuration for the wireless client transmitting the message.

5. The method for implementing neighbor discovery protocol in a WLAN according to claim 3, further comprising: transmitting the message to a wired network via a multicast mode when the message is transmitted by the AP to the at least one wireless client included in the logic group of the message via the unicast mode.

6. The method for implementing neighbor discovery protocol in a WLAN according to claim 1, further comprising:
when the neighbor discovery protocol related message is a router advertisement message, obtaining a time value contained in the retransmission timer field of the router advertisement message, and taking the time value as the maximum retention time in the AP of one of a router solicitation message, a router advertisement message, a neighbor solicitation message and a neighbor advertisement message when one of the router solicitation message, the router advertisement message, the neighbor solicitation message and the neighbor advertisement message is transmitted to the at least one wireless client by the AP via the unicast mode.

7. The method for implementing neighbor discovery protocol in a WLAN according to claim 1, wherein the wireless client is a host or a router.

8. An access point (AP) in a wireless local area network (WLAN), comprising: a storage unit, a receiving unit, a logic group determination unit and a transmitting unit; wherein
the storage unit is to prestore the logic group of each wireless client associated to the AP;
the receiving unit is to receive a neighbor discovery protocol related message, and provide the message to the logic group determination unit and the transmitting unit;
the logic group determination unit is to determine the logic group of the neighbor discovery protocol related message after receiving the message from the receiving unit; and
the transmitting unit is to transmit the neighbor discovery protocol related message to at least one wireless client included in the logic group of the message via a unicast mode, respectively, according to the logic group of each wireless client associated to the AP prestored in the storage unit and the logic group of the message determined by the logic group determination unit, after receiving the neighbor discovery protocol related message from the receiving unit.

9. The AP according to claim 8, wherein the neighbor discovery protocol related message is transmitted from a wired network via a multicast mode; and
the logic group determination unit is to: determine whether the message carries a logic group identifier, and in response to a determination that the message carries the logic group identifier, take the logic group identified by the logic group identifier carried in the message as the logic group of the message; and in response to a determination that the message does not carry the logic group identifier, take the default logic group of the interface from which the message is received in the AP as the logic group of the message.

10. The AP according to claim 8, wherein the neighbor discovery protocol related message is transmitted from a wireless client via a multicast mode; and
the logic group determination unit is to: determine the logic group of the wireless client from which the message is transmitted according to the logic group of each wireless client associated to the AP prestored in the storage unit, and take the logic group of the wireless client from which the message is transmitted as the logic group of the message.

11. The AP according to claim 10, wherein the logic group determination unit is to: determine the logic group of the message according to one of the virtual local area network (VLAN) to which the wireless client transmitting the message belongs, the service set identifier (SSID) of the wireless client transmitting the message, and the logic group managing configuration for the wireless client transmitting the message.

12. The AP according to claim 10, wherein the transmitting unit is further to: transmit the message to a wired network via a multicast mode when transmitting the message to the at least one wireless client included in the logic group of the message via the unicast mode.

13. The AP according to claim 8, further comprising:
a message retention unit to obtain, when the neighbor discovery protocol related message is a router advertisement message, a time value contained in the retransmission timer field of the router advertisement message, and take the time value as the maximum retention time in the AP of one of a router solicitation message, a router advertisement message, a neighbor solicitation message and a neighbor advertisement message when one of the router solicitation message, the router advertisement message, the neighbor solicitation message and the neighbor advertisement message is transmitted to the at least one wireless client by the transmitting unit via the unicast mode.

14. The AP according to claim 8, wherein the wireless client is a host or a router.
